(19) United States
(12) Patent Application Publication
(10) Pub. No.: US 2012/0191507 A1
(43) Pub. Date: Jul. 26, 2012

(54) System for unifying and collaborating new product development activities across a disparate set of users

(75) Inventors: Michael Bramworth, Cheltenham (GB); Peter Hoyland, London (GB); Jonathan Platt, Cambridge (GB)

(73) Assignee: BUBBLE GROUP LTD, London (GB)

(21) Appl. No.: 13/195,173

(22) Filed: Aug. 1, 2011

Related U.S. Application Data
(60) Provisional application No. 61/371,956, filed on Aug. 9, 2010.

(51) Int. Cl. G06Q 10/06

(52) U.S. Cl. 705/7.36

(57) ABSTRACT

A Portfolio and Project Management and new product development system is disclosed. In particular, the system in one embodiment includes a user, a user computing device, a client application, an operating system, a network interface, a server, a software-as-a-service (“SaaS”) platform, applications such as contact lists, documents, mail, etc., project management software which contains various views and sub-views, and sets of rules and criteria that interact with the project management software to manage the project management software output. In particular, the system of the present invention provides additional intelligence for customizing project management solutions for environments that use structured development methodologies, such as a stage and checkpoint process. Additionally, the system allows for real-time status updates and consistent reporting structures thereby increasing efficiency and project oversight at higher levels within an organization Furthermore, the system of the present invention allows for simultaneously editing by multiple users.

### BACKGROUND OF THE INVENTION

Projects Management within the field of new product development (NPD) often uses a specific technique of predetermined “stages” that are designed to break projects into sequential phases punctuated by predefined checkpoints (sometimes known as “gates”) where the project is reviewed. At each checkpoint, a decision is made as to whether the work item is viable enough to proceed to the next stage. These checkpoints provide for a structured work flow that forces projects onto a sequential, structured path. However, this multi-step checkpoint process may vary between groups or departments within an organization depending on specific needs and/or internal structure.

Software packages such as MS Excel® spreadsheets, and MS Project® are examples of software tools that may be used for managing new product development projects. However, these software packages, as well as other commercially available software packages, while useful, have limitations in their relevancy and effectiveness in successfully managing two commercially important aspects of New Product Development i) The checkpoint process of each project, and ii) The Portfolio of projects as a collection, and most importantly the linking of the two.

For instance, a common problem with existing systems is that they do not proactively collect the critical questions and key criteria that are most relevant to the checkpoint review team and the overall project. This can lead to inefficient meetings and delayed project progress. Existing systems provide project status in a very linear fashion. That is, they provide status on, for instance, the work that has been completed, what the current cost projections are, updated timelines, etc. While these are certainly important aspects of a project, their very nature leads a checkpoint review team to spend a disproportionate amount of their time “quizzing” the project manager on aspects of the project that may or may not be related to the information that has been shown, rather than focusing on the key issues that really determine the viability of the project. Aside from the time inefficiency, this style of review can create an antagonistic culture, which can affect overall project performance.

Additionally, from a mechanical standpoint, most of the existing new product development systems presently use template attachments, such as word processor and spreadsheet documents, to capture project progress. Because the templates are attachments and not integrated with the new product development system there is typically a problem allowing simultaneous access and the process of collecting and consolidating data from multiple development teams and subsequently packaging this data in a way that will be useful for the checkpoint review team remains manual and time consuming. This method of reviewing project status is extremely inefficient and inconsistent and creates challenges at all levels of the project.

A further problem in many project management and new product development systems is a lack of useful data views. Specific, targeted, and useful data views data are essential to any robust project management system. At the highest level, for instance, executive management, a portfolio view is generally preferred. At this level, an executive may quickly review the status, timeline and potential roadblocks for all projects which they have oversight or responsibility for. The next level of users is often a checkpoint review team. This group of users is generally responsible for performing checkpoint reviews and making go/no-go decisions for a specific project. The checkpoint review team requires information in a consistent, consolidated format.

The next level down is often the project management level. The project manager needs to be able to see how the various components of the project are functioning on a regular basis (i.e. hourly or daily), such that they can control the project and its various components. Existing systems generally fail to provide this information because they are insufficiently judgemental. Project team members are directed to perform tasks and can duly record their completion. However the quality of their work or the conclusions that should be drawn from the results of this work do not register within the systems. The project manager is not automatically informed of problems and those areas of the project that need his or her attention. Finally, project team members who are responsible for managing the day to day activities of the projects and providing updates as to the progress of their particular work are generally just task driven and this is often inappropriate in the new product development environment. It is much more important to understand precisely why each task is required, what question is really being asked and what criteria really need to be met.

In the most efficient systems, all users are presented with a view that is customized and specific to their particular level and facilitates more effective presentation of project status. While current systems have some capabilities to generate status presentations, the generated presentations are often stand-alone presentation files. In most cases, the generated presentations simply include selected paragraphs from a template pasted into slides, which provides no added value to the checkpoint review process. Because of this, if a checkpoint review team has questions regarding the underlying data for a given recommendation, there is no simple way for the presenter to show this data to the review team. Additionally, a project manager must generate a new presentation any time they may wish to see a project status report.

Another shortcoming of present new product development systems lies in the design of the templates themselves. Current templates in new product development systems generally record tasks completion or provide space for free text inputs and comments from the project team members. A typical example would be “Describe the operational feasibility of this concept” which may require manually writing a full paragraph to answer correctly. Because this information is in paragraph form, it cannot automatically be summarized for a checkpoint presentation without being reviewed by a project manager. Answers in paragraph form are also not structured in a way that ownership by theme, function, or subject can be easily allocated across the development team.

Yet another challenge with existing software and systems is that they have not taken advantage of new developments in “Cloud Computing” and Software-as-as-Service (SaaS) delivery models. In cloud computing, data and applications reside on a server or network that is typically hosted by a third party, i.e. Google, Microsoft, etc. For instance, web email, such as Yahoo! Mail or Gmail, are examples of applications that are delivered through cloud computing. SaaS is software that is deployed over a network, such as the internet and/or behind a firewall in a local area network or personal computer. In the SaaS model, a customer accesses an application hosted by a provider and pays for the service through a predetermined model, i.e. subscription, “pay-as-you-go,” etc. Given the ubiquitous accessibility of the internet, one benefit of the SaaS/Cloud Computing model is software designed to allow users to collaborate and share more efficiently.

This functionality is of tremendous benefit to business activities like project management and new product development.

For these reasons, a need exists for a system that effectively allows an organization to implement a corporate-wide, standardized platform for managing project and product development activities.

### DESCRIPTION OF THE INVENTION

The present invention is a system for managing project and product development activities collaboratively across a group of users. In particular, the present invention provides an integrated platform which allows users in various roles within an organization to view and edit a single source of real-time data specific to the activity or activities they are engaged in.

The foundation of this system is a database which can be interrogated and updated via a graphical user interface that is itself delivered and accessed by, for example, a Software-as-a-Service (SaaS) platform.

The database can be translated into “themed templates” within the system. Themed templates leverage historical experience and internal corporate expertise to identify a series of areas in which the progress of the business activity should be monitored, for instance, marketing, sales planning, supply chain, etc. These custom areas are then used to track activity progress through the various stages and checkpoints.

It is important to note that themed templates are distinctly different than traditional checklists offered by other business process systems. Themed templates rely on judgmental outcomes, which may be answered with simple “yes” or “no” answers, as opposed to lists of tasks, i.e. “is the refreshed business plan still acceptable?” vs. “prepare the business plan”. This translation of tasks into genuine, pre-determined, criteria is one of the key features that distinguishes this system from traditional project management methods. These judgemental criteria allow new product development to be managed as a process rather than as a collection of projects. A process is stable, measurable, repeatable and improvable. A collection of projects is none of these. Questions within each of the one or more themed templates may be tiered, such that there is a summary question which may be automatically updated based on the answers to more specific supporting questions.

Ideally, the “yes” and “no” questions are selected so that when answers have been obtained for all such questions in a given stage, all of the information required to determine whether or not development can proceed to the next stage has been obtained. With existing project development systems, new issues often arise in connection with checkpoint reviews. Tracking down answers to these new issues can impede the decision making process. In addition, when the development process features multiple layers of development information that feed into a dashboard or other project summary interface, the creation of new content by an employee managing the staged process in order to respond to such new issues can reduce the effectiveness of the dashboard or other summary. This reduction in effectiveness occurs because the dashboard is not updated as quickly as it might otherwise be if a user of the system did not have to create new content in response to new issues raised in connection with checkpoint review.

With conventional staged product development systems, just financial and technical information is typically considered. The present system is structured to permit the collection of information in other relevant categories, e.g., environmental impact, packaging requirements, and marketing plans, which information may also be used in determining whether or not a development project has advanced to the point that it is ready to pass to the next stage.

If desired, supporting evidence may be attached directly to at least one of the “yes” and “no” questions as at least one of a lower level set of “yes” and “no” questions, text, data tables and separate files. In addition, further details and supporting evidence may be associated with each “yes” and “no” question if desired.

By defining gate progress in terms of judgmental outcomes, this system represents a platform that is truly universal for all projects, i.e., all projects can use and be defined and measured by the same criteria. The usage of judgmental outcomes also enables the system to automatically provide answers to high level business questions in project and portfolio views without the need for a manager to review the content of the particular answers within the template. These templates provide the flexibility and functionality to efficiently create any output views needed by the project team.

Additionally, the project team may quickly and efficiently add new themed templates to the system with the appropriate permissions. For instance, if a company was looking to monitor new projects based on their environmental impact, an “environmental” theme could be added. Going forward, all new projects would have to adhere to and meet requirements defined in the theme to proceed through the checkpoint process.

The themed templates automatically roll up to higher level project and portfolio views, wherein one or more projects comprise a portfolio. Each of the views and templates within the system is linked such that updates to the underlying data in the templates results in automatic changes to all views related to that data. Since the system is built on a cloud computing platform, these updates may also occur in real time as changes are made. This allows, for instance, an executive to obtain real time status updates at the portfolio level or a project manager to view all of their projects under management at the project level. These linkages between templates and views also provide an efficient way for a presenter in a gate review meeting to quickly demonstrate the underlying data for a particular recommendation. This creates efficiencies in terms of management and reporting within the organization.

The project view aggregates information from the themed templates and presents various sub-views that are useful for managing the project. In a preferred embodiment of the current invention, sub-views within the project view may include a financial summary, project dashboard, various status charts, etc. All information displayed within the project view is obtained directly from the template level. Therefore, there is a consistent presentation of status and project progress that is based on data provided from the “bottom up.”

The portfolio view is the highest level view within the system. The portfolio view shows the status of one or more projects contained within the portfolio.

The system further includes a feature to link the various levels of the system to develop specific rules or criteria that will govern what a user sees in the template, project, and portfolio views. For instance, a project manager may only be interested in tracking a series of critical events in a specific area of their project. The project manager may establish a rule in the project view to show them only the status of those particular events. In addition, the project manager may elect to receive an email notification when other non-critical events have been completed so they remain in sync with total project status. This level of flexibility is a great asset to all levels of project participants, as it further serves to provide a user with the most relevant information for their particular role or situation.

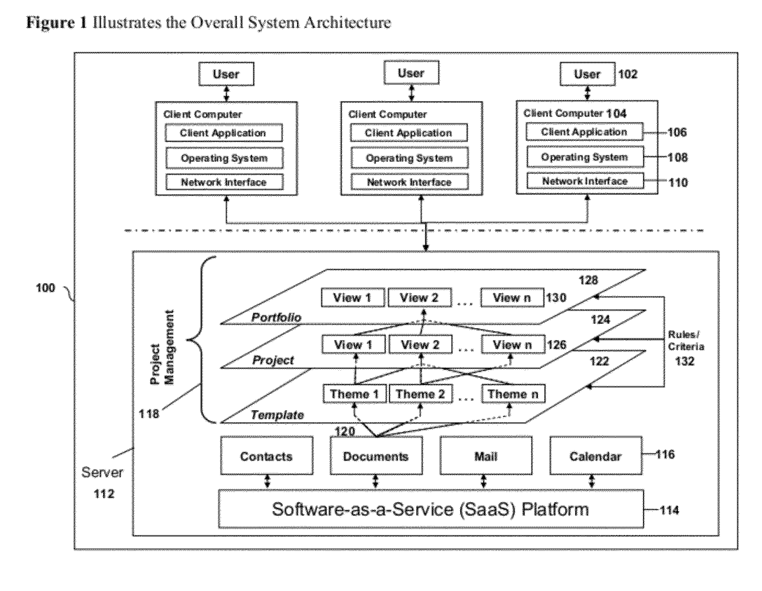

FIG. 1 illustrates a functional block diagram of one embodiment of the system 100 in accordance with the invention. The system includes at least one computer user 102, a client computer 104, wherein said client computer contains a client application 106, an operating system 108, and a network interface 110. The network interface 110 connects to a server 112, wherein said server 112, contains a software-as-a-service (“SaaS”) platform 114, applications such as contact lists, documents, mail etc. 116, project management software 118 which links to a document view 120, a themed template view 122, a project view 124 with one or more sub-project views 126, a portfolio view 128 with sub-portfolio views 130, and sets of rules and criteria 132 that interact with the project management software 118.

The user 102 may be any individual that is involved in a business process management role. Client computer 104 may be any standard desktop, laptop, tablet computer, handheld smart phone or networked computer. Client computer 104 contains a client application 106 which may be any software application capable of interfacing with a Cloud/SaaS platform over a network such as but not limited to business management software applications, web browsers, such as but not limited to Microsoft Internet Explorer, Mozilla Firefox, or Apple Safari, or any such similar application. Client computer 104 further contains an operating system 108 such as Microsoft Windows®, Apple Mac OS X, or Linux, and a network interface 110 that allows client computer 104 to connect with a server.

Networked server 112 may be any standard networked computer or internet server capable of storing information or applications to be accessed by at least one user 102 of the system 100 via network interface 110 on client computer 104. Networked server 112 contains a software-as-a-service (SaaS) platform 114, such as but not limited to Microsoft Sharepoint® or Google Documents, wherein said SaaS platform is software which may be deployed, for example, over the internet or run behind a firewall in a local area network. The SaaS platform 114 further contains suites of applications 116 such as but not limited to contact list applications, mail applications, document editing applications, and calendar applications.

Applications 116 are integrated with project management software 118. The project management software 118 contains one or more individual themed template views 122 wherein said individual themed template views contain a detailed breakdown from project management area and metrics such as, for example: Resource Requirements, Design, Manufacturing, Marketing, Quality Assurance, Operations & SC, and Finance.

The one or more sub-project views 126 contain summaries of each of the one or more individual themed template views 122. The summaries of the one or more individual themed template views 122 contained in the sub-project views 126 contain information such as specific questions for each project management area, the specific questions for each stage and information as to the status of the project management area relative to each gate and each pass/fail gate decision if applicable.

Each of the one or more individual sub-project views 126 may then be rolled up into an overall project view 124. This overall project view 124 contains summaries of the combined one or more individual sub-project views 126 data such as dates for each checkpoint and whether that checkpoint has been passed/failed, overall project target date, financial information such as P&L statements anticipated NPV, and cash flow, a project dashboard that details what individual steps are completed/incomplete for each sub-project category and other project details.

Each project view 124 is then rolled up into a high level portfolio view 128. The portfolio view provides a summary of multiple project views 124 and contains an overview of each project for example: Project Number, Project Manager, Project Type, Launch Date, Next Gate, Net Present Value, Total Investment, EBITDA, IRR, Primary Development Site, Primary Manufacturing Site, Project Size and Business Team. The portfolio view 128 may also include corresponding charts for example aggregated resource requirements and total projected revenues, a portfolio roadmap and project ideas. Real time generation of portfolio views facilitates management decisions on the relative importance and values of individual projects.

The project management software 118 is governed by rules/criteria 132 that transforms the data generated by each of the one or more themed template views 122, project views 124 the sub-project views 126, a portfolio view 128 and the sub-portfolio views 130 into the summary views and incorporates customized data into each view;

In operation, the user computer 104 connects to the server 112 via the network interface 110. The user 100 can then interact with the project management software 118 of the SaaS platform 114 through the client application 106 on client computer 104 to view specific project management details and manipulate the data therein for example via editing or printing. Additionally, one or more users 100 can manipulate the data in the SAAS platform applications 116 at the substantially the same time. These changes will be monitored by the rules/criteria 132 component and change the one or more themed template views 122, project views 124 and portfolio views 128 as necessary.

The system further includes a feature whereby a computer user 102 can guide another computer user 102 to the specific screens that they are viewing by setting a flag on their screen to “share” the web address that they are viewing. The second user will simply click on the share icon on their own screen and it will immediately direct them to the screen being viewed by the first viewer. The benefit of this feature is to enable a project review or checkpoint review to take place whilst people are geographically separated. The meeting chairman can use this device to guide the participants to particular screens and views within the system, without the participants needing to relinquish absolute control of their computers to the chairman.

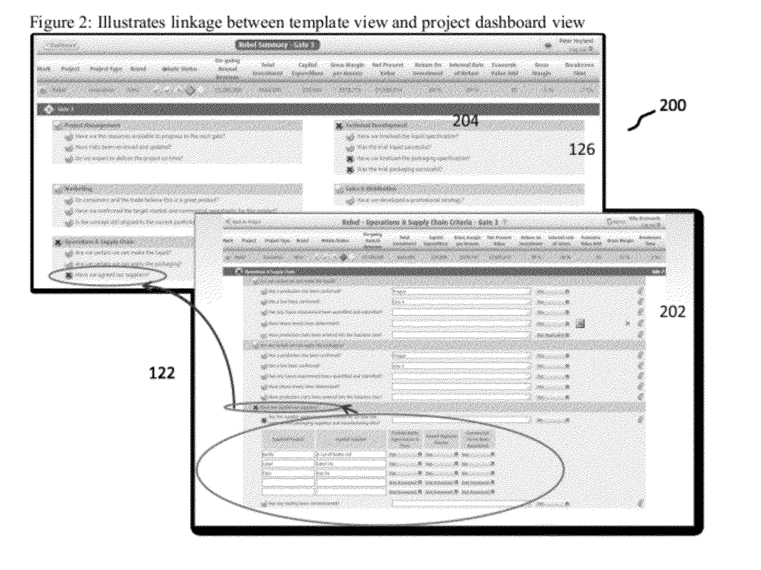

FIG. 2 illustrates a preferred embodiment of the relationship and correlation 200 between a themed template view 122 level and the project level. Based on a set of specific themes, such as for example Marketing, Finance, or Manufacturing, for which the user would like to have as input into the checkpoint review process, a set of requirements and judgmental outcomes may be developed to monitor each of the desired inputs, and may be shown at the sub-project view 126. Once the template contains the appropriate list of requirements and potential outcomes 202, it may become a standard form within the project management system 118. All activities may now utilize this template as part of the overall project management process. Real time feed of data from the system to other management systems, including gate dates, launch dates and financial data, may be provided with the present system if desired.

A first user from said one or more users 102, such as for example a member of a project team, may be able to access the template and make updates on either an individual basis or in conjunction with an at least second user from said one or more users 102. In a preferred embodiment of the invention, the system may be able to accommodate as many as, for example, 50 users, such that said first user may be able to make changes in conjunction with as many as, for example, 49 other users. When any of said one or more users 102 updates the template, the template may automatically push the update to the project level 124. At the project level, all updates from the template level may then be aggregated and a summary view may be provided for each theme 204. A separate template exists for each theme depending which stage the project is currently in.

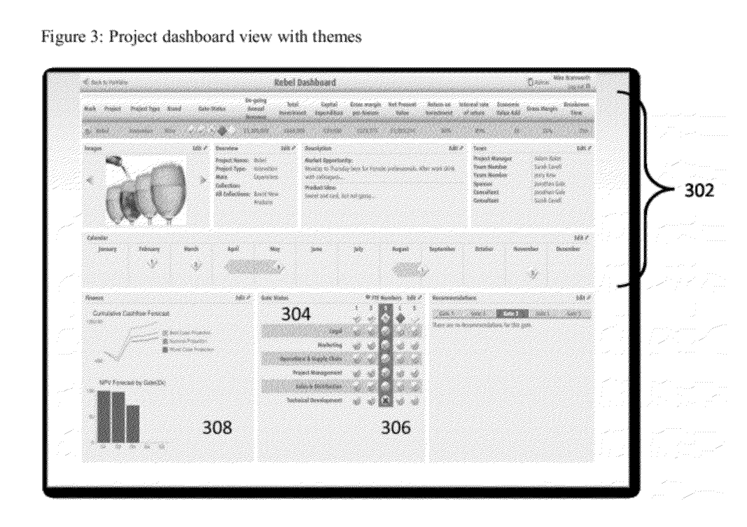

FIG. 3 illustrates a preferred embodiment of a view 300 at the project level 124 of project status. Within this view 300, an overall project status 302 is shown which provide a user with general project information such as gate, project timeline, NPV, and other project metrics and parameters. Project themes 304 are displayed in the main viewing area and provide the user with an immediate status report by using a series of colored indicators 306; for instance a red cross may indicate that the requirements for a specific task has not successfully met the checkpoint criteria. Specific project financial data 308 is presented graphically as well as being available in tabulated form.

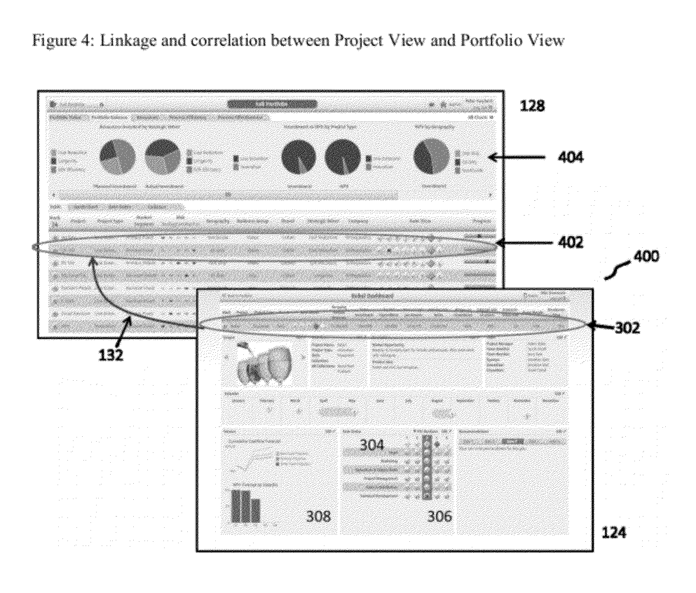

FIG. 4 illustrates a preferred embodiment of the relationship and correlation 400 between the project view 124 and the portfolio view 128. Overall project status 302 information in the project view 124 may be linked to project overview information 402 in portfolio view 128 using a rule or criteria 132. Portfolio view 128 may further display said project overview information 402 graphically as charts and/or graphs 404.

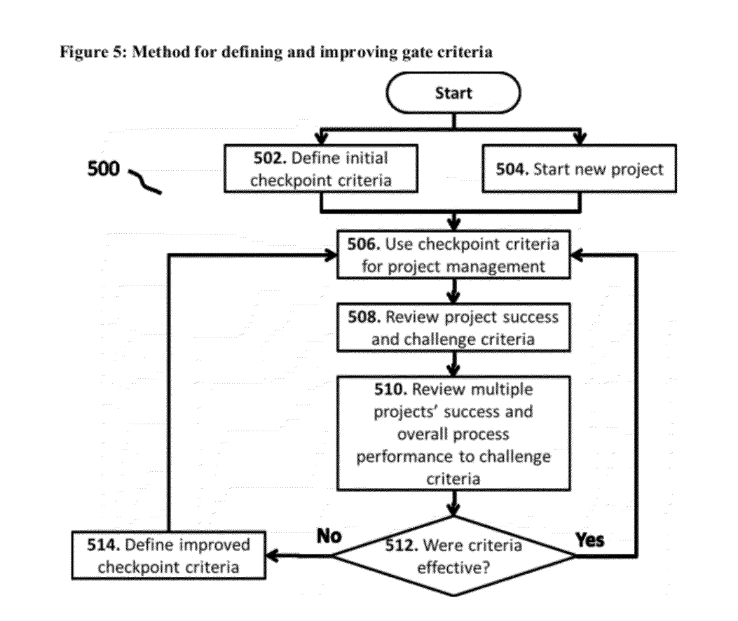

FIG. 5 illustrates a flow diagram for a method of using checkpoint criteria for project management 500 with a project management application 118.

### Step 502: Define Initial Checkpoint Criteria

In this step, at least one user 102 may define one or more gate criteria for a project, such as a new product development project, such that project progress may be evaluated accurately and efficiently.

### Step 504: Start New Project

In this step, at least one user 102 may define a project that will be progressed and evaluated using the system and the checkpoint criteria

### Step 506: Use Checkpoint Criteria for Project Management

In this step, at least one user 102 may define one or more judgmental outcomes for each of the one or more gate criteria defined in step 502 for the present project. A judgmental outcome is an activity that should be completed or criteria that should be satisfied before the review team allows it to pass through the current gate. The review team can however choose to pass a project through a gate when a judgmental outcome does not meet the defined criteria if they collectively judge the risk to be acceptable in consideration of the overall project opportunity.

### Step 508: Review Project Success and Challenge Criteria

In this step, at least one user 102 may evaluate the success of the project, either once the project has been completed or at some interim stage of completion and, based on this evaluation, determine whether the criteria for each checkpoint were as effective as possible in optimizing the project success.

### Step 510: Review Multiple Projects' Success and Overall Process Performance to Challenge Criteria.

In this step, at least one user 102 may use project management application 118 to track the overall performance of the system and process and to determine whether the criteria for each checkpoint were as effective as possible in optimizing the overall project success rates.

### Step 512: Begin New Project?

In this step, at least one user 102 may consolidate the learnings from individual project evaluations 508 and also from the overall evaluation 510 to determine the extent to which criteria should be modified.

### Step 514: Define Improved Checkpoint Criteria?

In this step, at least one user 102 may define modified or additional checkpoint criteria which are then incorporated into the system for all future projects of that same type. In this way the expertise that is built into the system is able to continually evolve and improve over time.

Certain embodiments of the invention facilitate effective management and completion of critical business activities, in particular project management and new product development, through a common platform that is robust, collaborative, and unified.

System users will find that various implementations of the invention support the proactive collection of key questions and project criteria that are most relevant to the gate review team. By determining what information is most relevant to the gate review teams within an organization, and building a standardized platform which all projects must work from, a company can increase the level of consistency and efficiency within its new product development activities.

A benefit of certain embodiments of the invention is that new questions, issues, themes or other project aspects may be added to all future projects by updating a standard list that all projects reference at their inception.

An advantage of embodiments of the invention described above is that multiple users can work on and edit the same template, i.e., a “single copy” simultaneously. Use of this “single copy” alleviates common problems associated with business process software, such as version control, rights, management, and document security. Furthermore, by having a “single copy” as the foundation of the application, data contained within the template can be rolled up to higher level views on a real time basis.

Another benefit of various implementations of the invention is that the underlying software can be used to display a variety of GUI views, from detailed action steps to high level executive summary views.

What is claimed is:

1. A computer implemented method of managing a new product development process comprising:
a) developing a plurality of questions that can be answered with “yes” or “no” answers for use in a new product development stage and checkpoint review process, wherein the plurality of questions are created to address a predetermined set of issues in a predetermined set of categories that when satisfied indicate the new product development has advanced sufficiently to permit the checkpoint review process to proceed from one of the plurality of stages to the next, further wherein the plurality of questions are presented in a software user interface;
b) connecting across a global communications network a plurality of users to a software application program used to capture information necessary to answer the plurality of questions, wherein the plurality of users are connected and the software application program is constructed so that the plurality of users can substantially simultaneously access and edit the software application program;
c) clicking on at least one of the “yes” and “no” question to reveal further details and supporting evidence;
d) providing answers to all of the plurality of “yes” and “no” questions;
e) using the answers provided to the plurality of questions for a plurality of projects to create rolled up performance measures at the portfolio level
f) clicking on at least one of the projects within the portfolio to reveal further details and supporting evidence about that project;
g) attaching supporting evidence directly to at least one of the “yes” and “no” questions as at least one of a lower level set of “yes” and “no” questions, text, data tables and separate files;
h) creating a tabulated form that can be linked to one or many of the “yes” and “no” questions within the system to capture specific project data
i) evaluating whether or not the new product development is ready to proceed to the next stage based on the answers.
j) By means of classifying each project as a type, establishing standard resource profiles for each type and thereby generating an overall resource requirements plan for at least one collection of projects
